(19) United States
(12) Patent Application Publication
(10) Pub. No.: US 2026/0364507 A1
(43) Pub. Date: Nov. 19, 2026

(54) INBOARD SUPPORT PANEL

(71) Applicant: Baldwin Filters, Inc., Cleveland, OH (US)

(72) Inventors: Joshua W. Witte, Kearney, NE (US); Levi W. Dexter, Elm Creek, NE (US); Timothy L. Krull, Kearney, NE (US)

(73) Assignee: Baldwin Filters, Inc., Cleveland, OH (US)

(21) Appl. No.: 19/722,019

(22) Filed: Jun. 26, 2026

Related U.S. Application Data
(63) Continuation of application No. PCT/US2024/051969, filed on Oct. 18, 2024.
(60) Provisional application No. 63/623,439, filed on Jan. 22, 2024.
(60) Provisional application No. 63/564,155, filed on Mar. 12, 2024.

(51) Int. Cl. B01D 46/52; B01D 46/00

(52) U.S. Cl. CPC B01D 46/521; B01D 46/0001; B01D 46/0005; B01D 2265/04; B01D 2271/02

(57) ABSTRACT

A filter assembly includes a media pack having a sheet of pleated filter media. The sheet of pleated filter media has a plurality of pleat panels. A first support panel is placed between two adjacent pleat panels in the plurality of pleat panels. A gasket is configured to circumscribe the media pack. Furthermore, the gasket is attached to the media pack.

### CROSS-REFERENCE TO RELATED PATENT APPLICATIONS

This patent application is a continuation of co-pending International Application No. PCT/US2024/051969, filed Oct. 18, 2024, which designates the United States, and which is now pending. The entire teachings and disclosure of International Application No. PCT/US2024/051969 are incorporated herein by reference thereto. International Application No. PCT/US 2024/051969 claims the benefit of U.S. Provisional Application No. 63/564,155, filed on Mar. 12, 2024, and claims the benefit of U.S. Provisional Patent Application No. 63/623,439, filed Jan. 22, 2024, the entire teachings and disclosure of which are incorporated herein by reference thereto.

### FIELD OF THE INVENTION

The present invention generally relates to an air filter, and more specifically to an air filter in which the filter media pack incorporates one or more support panels.

### BACKGROUND OF THE INVENTION

Filter systems are used for filtering fluids (i.e., liquids or gases) to remove contaminants. The filter system often includes replaceable filter elements that are removable from the system that can be replaced when spent without having to replace the entire system. The replaceable filter element often includes a block of filter media, often called a media pack and a seal for sealing the media pack within the system to prevent dirty fluid from bypassing the media pack.

For example, a variety of air filters are known, for example, as shown in U.S. Pat. No. 6,824,581, titled “Pleated Filter Media with Embossed Spacers and Cross Flow”; U.S. Pat. No. 5,820,646, titled “Inline Filter Apparatus”; U.S. Pat. No. 11,406,924, titled “Filter with Protective/Supportive Flow Face Grating”; PCT Publication WO 91/19898, titled “Filter and Process for Manufacturing of Filter”; and U.S. Patent Application Publication No. 2018/0111079 titled “Air Filter With Outlet Receiver and Housing Assembly Incorporating Same”; the teachings and disclosures of which are incorporated by reference herein in their entireties.

Embodiments of the present invention provide improvements over the current state of the art as it relates to filter elements for filtering fluid and particularly filter elements that include seal support frames and/or filter media support members, and more particularly filter elements that are generally rectangular in shape. These and other advantages of the invention, as well as additional inventive features, will be apparent from the description of the invention provided herein.

### BRIEF SUMMARY OF THE INVENTION

Embodiments of the present invention use the geometry of the media pack pleat to lock at least one support panel into position, thus eliminating the need for adhesive and for media support members. Incorporating a support panel into and as part of the media pack can eliminate the need for adhesives to secure the support panel to the media pack and can reduce external support structures over a filter media pack.

In one aspect, embodiments of the invention provide a filter assembly that includes a media pack comprised of a sheet of pleated filter media with a plurality of pleat panels and with at least as first support panel that is placed between two adjacent pleat panels in the plurality of attached pleat panels. A gasket is configured to circumscribe the media pack, the gasket being attached to the media pack.

In a particular embodiment, the sheet of pleated filter media includes a first additional panel attached to a last pleat panel at a first end of the sheet of pleated filter media, and the first additional panel is configured to wrap around the first support panel to fix the first support panel in position within the media pack. In a more particular embodiment, the first additional panel is shorter in length than the first support panel.

The filter assembly may further include a second support panel, wherein the first support panel is placed between two adjacent pleat panels at a first end of the sheet of pleated filter media, and the second support panel is placed between two adjacent pleat panels at a second end of the sheet of pleated filter media, the second end being opposite the first end. As such, the first and second support panels are not connected.

Additionally, the sheet of pleated filter media may include a pair of additional panels, in which one of the pair of additional panels being attached to a last pleat panel at the first end of the sheet of pleated filter media, and in which the other of the pair of additional panels being attached to a last pleat panel at the second end of the sheet of pleated filter media, and where the pair of additional panels are each configured to wrap around one of the first and second support panels to fix the first and second support panels in position within the media pack such that the support panels are incorporated as part of the media pack.

In at least one embodiment, the filter assembly further includes a third support panel disposed within the media pack between the first and second support panels. Thus, in this example, the third support panel is not connected to either of the first and second support panels. In another embodiment, at least one of the first and second support panels is a thin, flat board. The support panel could be a perforated or impervious board. The filter assembly may also include a pair of end caps attached to opposing ends of the media pack such that the first and second support panels each extend from one of the pair of end caps to the other of the pair of end caps.

In some embodiments, the gasket is attached to the media pack using an adhesive.

The filter assembly may further include one or more adhesive strips placed across an upstream or inlet face of the media pack.

Further still, the filter assembly may include a gasket support structure integral with the gasket, the gasket support structure configured to structurally support the gasket and to facilitate attachment of the gasket to the media pack.

In another aspect, embodiments of the invention provide a method of manufacturing a filter assembly, the method including the steps of pleating a sheet of pleated filter media, where the sheet of pleated filter media has a plurality of attached pleat panels. The method also includes inserting a first support panel between two adjacent pleat panels of the plurality of attached pleat panels, and attaching a gasket to the media pack such that the gasket circumscribes the media pack.

In a particular embodiment, the method includes providing the media pack with a first additional panel attached to a last pleat panel at a first end of the sheet of pleated filter media, where the first additional panel is configured to wrap around the first support panel to fix the first support panel in position within the media pack.

In many embodiments, the method will further include inserting a second support panel between two adjacent pleat panels of the plurality of attached pleat panels, where the first support panel is inserted between two adjacent pleat panels at a first end of the sheet of pleated filter media, and the second support panel is inserted between two adjacent pleat panels at a second end of the sheet of pleated filter media, the second end being opposite the first end.

The method may also call for providing the media pack with a pair of additional panels, such that one of the pair of additional panels is attached to a last pleat panel at the first end of the sheet of pleated filter media, and such that the other of the pair of additional panels is attached to a last pleat panel at the second end of the sheet of pleated filter media, and the pair of additional panels are each configured to wrap around one of the first and second support panels to fix the first and second support panels in position within the media pack.

In some embodiments where additional stiffness may be desired, the method requires inserting a third support panel within the media pack between the first and second support panels.

Further still, the method may call for attaching a pair of end caps to opposing ends of the media pack such that the first and second support panels each extend from one of the pair of end caps to the other of the pair of end caps.

In certain embodiments, the method requires attaching a gasket to the media pack comprises attaching a gasket to the media pack using an adhesive.

In other embodiments, the method includes, placing one or more adhesive strips across an upstream or inlet face of the media pack.

The method may also include providing a gasket support structure integral with the gasket, where the gasket support structure is configured to structurally support the gasket and to facilitate attachment of the gasket to the media pack.

In yet another aspect, embodiments of the invention provide a filter assembly that includes a media pack comprised of a pleated sheet of media having alternating pleat peaks and pleat valleys defined by adjacent media panels. Each of the pleats has an upstream portion adjacent a first flow face of the media pack, and a downstream portion adjacent a second flow face of the media pack. The pack also includes a planar support member located between an outermost media panel and a first adjacent media panel.

In a particular embodiment, the media pack has a distal media panel folded internally so as to be located between a first inner media panel contiguous with the distal panel, and a second inner media panel contiguous with the first inner media panel. The first inner media panel defines the outermost media panel, and the distal media panel defines the first adjacent media panel. In a more particular embodiment, the planar support member is a flat, thin, impervious or perforated board.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded perspective view of a prior art air filter assembly;

FIG. 2, is a cross-sectional view of the prior art air filter assembly shown in FIG. 1;

FIG. 3 is an exploded perspective view of an air filter assembly, constructed in accordance with an embodiment of the invention;

FIG. 4 is a perspective view showing how a support panel is assembled into the media pack, according to an embodiment of the invention, which is representative of how support panels can be inserted at both opposite ends of the pleated filter media sheet.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

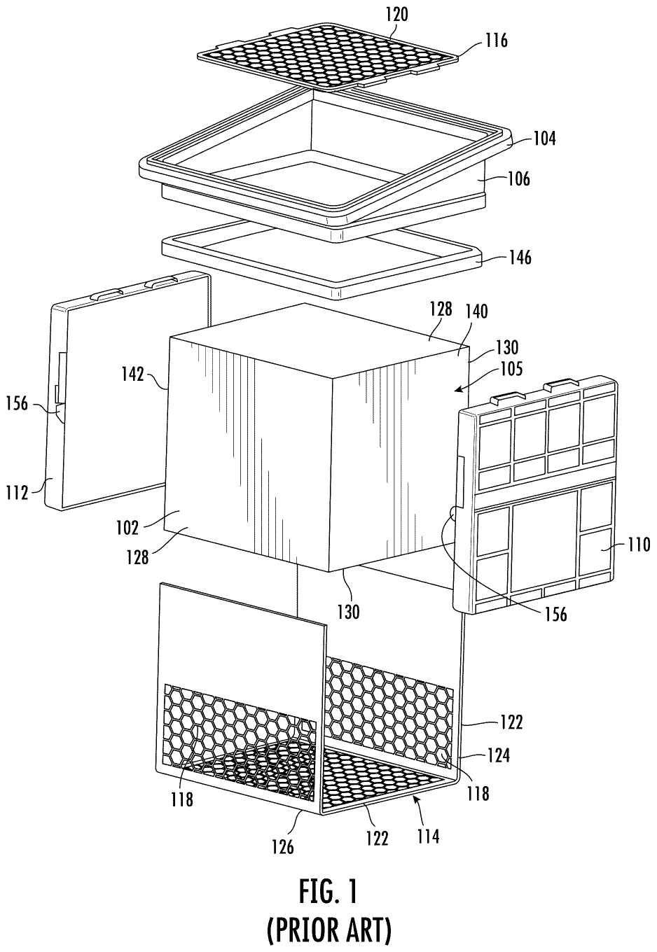

FIG. 1 is an exploded perspective view of a prior art air filter assembly 100 such as may be also seen in U.S. Pat. No. 11,406,924. In this example of a filter assembly 100, a media pack 102 includes filter media 105 for filtering a fluid (i.e., liquid or gas) to remove contaminants from the fluid. The media pack 102 may be surrounded by a gasket 104, which is attached to the media pack in such a way to create a seal between an interior surface of the gasket 104 and an exterior surface of the media pack 102. A gasket support structure 106 supports the gasket 104 to facilitate a seal between the gasket 104 and media pack 102.

The filter assembly 100 includes a pair of opposing end caps 110, 112. The media pack 102 and filter media 105 are situated between said end caps 110, 112. The filter assembly 100 includes one or more grates in the form of media support members 114, 116 at opposite flow faces, which provide structural support to the overall assembly 100 and specifically to the media pack 102 during both operation as well as initial manufacture.

In the example shown, these media support members 114, 116 include a U-shaped perforated media support member 114, and a flat perforated media support member 116. Although both media support members 114, 116 are shown, in some conventional filter assemblies, only media support member 114 may be employed. However, the inclusion of both media support members 114, 116 may be used to provide additional support to the media pack 102.

The media support member 114 is formed from molded plastic materials. Each of media support members 114, 116 includes perforations 118, 120, respectively. These perforations 118, 120 generally resemble a honeycomb structure and allow for air flow to and from the filter media face 128, 130 to which it is adjacent.

The exemplary media support member 114 possesses a U-shape such that it wraps over three sides filter media 105, wherein U-shaped media support member 114 includes a flow face support panel 122 and first and second side support panels 124, 126 on either side of flow face support panel 122. The media support member 114 extends over the first and second sides 132, 134 of the media pack 102 and the downstream face 130 to provide additional structural support to the media pack 102. s such, the first and second side support panels 124, 126 of media support member 114 overlap, at least in part, the first and second sides 132, 134 of the media pack 102. The flat media support member 116 extends across the upstream face 128. An adhesive may be applied to directly secure the media support member 114 to the filter media of the media pack 102.

In an example, the first and second side support panels 124, 126 and flow face support panel 122 are all formed from a continuous piece of material. The entire media support member 114 may be formed from a single continuous piece of material, such as by way of molding as a continuous piece of material, or machining from a single piece of material.

Media support member 114, along with filter media 105 are be potted in place between opposing end caps 110, 112.

Flat media support member 116 possesses a flat shape and is removably secured to opposing end caps 110, 112. “Removably secured” as used herein means secured in such a way that it may be repeatedly removed and reinstalled without destroying or otherwise rendering inoperative any of the remaining structure of filter assembly 100. Flat media support member 116 is positioned adjacent one of the upstream or downstream faces 128, 130 of filter media 105 which is opposite the face to which media support member 114 is adjacent.

To assist in installation and assembly of gasket support structure 106, each end cap 110, 112 may also include a stop 156 to provide an abutment for gasket support structure 106 as it is assembled onto the media pack 102 and opposing end caps 110, 112. These stops 156 axially locate gasket support structure 106. Further, an adhesive tape or band 146 may be employed to provide a dam between gasket support structure 106 and the adjacent surfaces of media support member 114 and opposing end caps 110, 112.

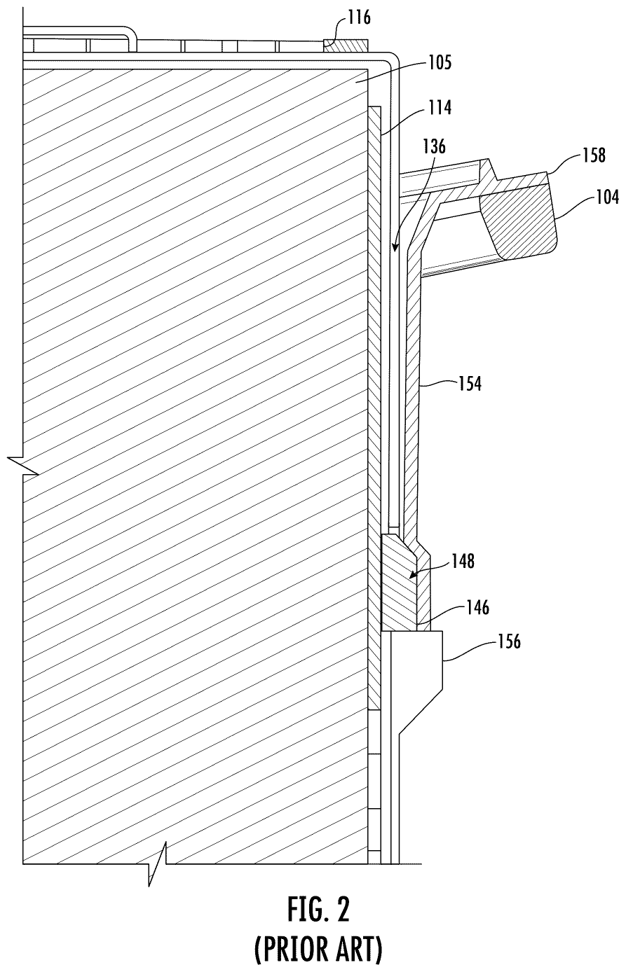

With reference now to prior art FIG. 2, this figure illustrates a cross-section taken through filter assembly 100 in a plane that is parallel to side faces 140, 142. Gasket support structure 106 includes a skirt 154 and a flange 158 depending outwardly from skirt 154.

As may be seen in this view, a well 136 is formed between an interior surface of skirt 154 and exterior facing surfaces of U-shaped media support member 114. Once the gasket support structure 106 is in position, an adhesive, urethane, or any other compound suitable for fixing gasket support structure 106 in place, is poured into well 136. This well 136 terminates at adhesive tape 146 which is contained within a terminal channel 148 formed by skirt 154. The adhesive tape 146 serves as a dam to prevent an outflow of the aforementioned urethane, adhesive, or any other compound prior to its full cure.

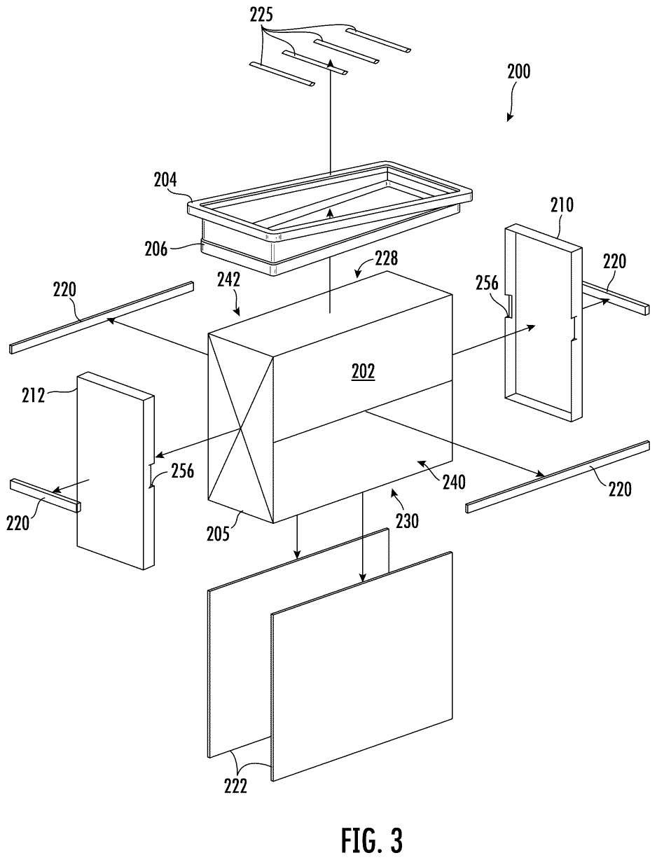

FIG. 3 is an exploded perspective view of an air filter assembly 200, constructed in accordance with an embodiment of the invention. The construction of that of filter assembly 200 is similar in some respects to that of filter assembly 100, and the same gasket support structure 106 carrying gasket 104 can be utilized and secured to the filter media pack. However, in filter assembly 200, various external structural components have been eliminated, and instead the filter media pack is enhanced to facilitate direct attachment, that may not need the U-shaped, perforated media support member 114, and the flat perforated media support member 116.

An embodiment of the filter assembly 200, according to the teachings herein, is illustrated. As will be explained in greater detail below, the filter assembly 200 is constructed to exhibit enhanced structural support of its associated filter media 205 without the use of media support structures. The aforementioned structural support is due in part to the inclusion of one or more support panels 222 as part of the filter media pack. As discussed herein, the support panels 222 may be flat, thin, impervious, or perforated boards capable of providing stiffness and structural strength to the media pack 202. In the example shown, the filter assembly 200 includes two support panels 222, though alternate embodiments may have fewer or more than two support panels 222. Each of the two support panels 222 extends along a face of the media pack 202 from one of a pair of opposing end caps 210, 212 to the other of the pair of opposing end caps 210, 212.

Similar to the filter assembly 100 of FIG. 1, filter assembly 200 includes a media pack 202 with filter media 205, and a pair of opposing end caps 210, 212 which can be secured to either side of the filter media pack to seal opposed ends, no matter the size (e.g., the same end caps 210, 212 can be used for longer or shorter filter media packs if desired). The media pack 202 between said end caps 210, 212. Filter media 205 may be embodied as any type of media, e.g., fluted, pleated, etc., and as such, the invention is not limited to any particular type of media. However, it has been found that the particular configuration performs significantly well with so-called deep-pleated filter media. Furthermore, additional rigidity to the pleated filter media sheet used in the filter media pack can be had as taught in any of the embodiments of U.S. patent application Ser. No. 63/622,958, filed Jan. 19, 2024, entitled VARIABLE HEIGHT, OFFSET, ANGLED & BRIDGED EMBOSSMENT, the entire teachings and disclosure of which are hereby incorporated by reference.

In certain embodiments, the filter media 205 is made from a pleated sheet of media having alternating pleat peaks and pleat valleys defined by attached and adjacent media panels, where each of the pleats has an upstream portion adjacent a first flow face of the media pack, and a downstream portion adjacent a second flow face of the media pack. The second flow face is opposite the first flow face. Pleating gives the filter media 205 an accordion-like appearance in which the filter media has a plurality of adjacent and attached pleat panels. In a typical embodiments, each of the plurality of pleat panels are the same size, though alternate embodiments may include filter media with pleat panels having different sizes. The filter media 205, as described, has a first end and a second end. In embodiments of the invention where the pleat panels are essentially identical, the first end and second end are similar in appearance.

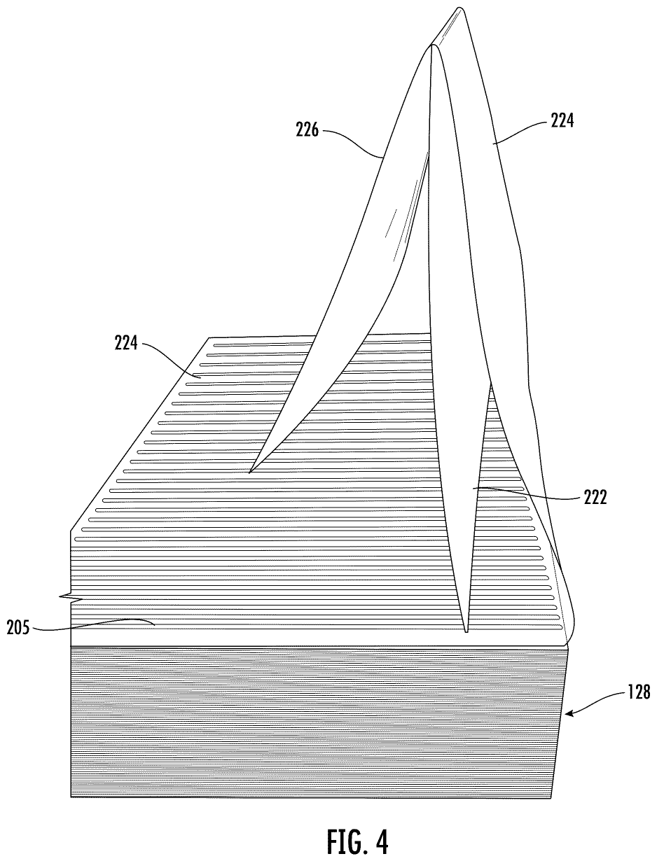

Additionally, at least some of the pleat panels will have embossments as discussed in the aforementioned Provisional Application No. 63/622,958, and as embossments can be seen for at least the inner pleat panels in FIG. 4 (at least outer pleat panels may be flat without embossments). Thus, the outermost panels may include embossments, or may be flat without embossments.

Still referring to FIG. 3, in certain embodiments, each opposing side cap 210, 212 may be pre-formed prior to its assembly to filter assembly 200. This pre-forming may be achieved via molding, additive manufacturing, or any other manufacturing process or processes. Such preformed type end caps may then be potted in place with adhesive. In other embodiments, the opposing side caps 210, 212 could be molded in place as mold-in-place end caps, such as direct application of a liquid urethane material in a removable mold to opposed ends, such that the end caps 210, 212 once cured are directly bonded to the ends of the filter media pack 202 (and the molds used therefore are removed to leave the mold-in-place end caps). In a specific embodiment, each opposing end caps 210, 212 includes a cavity for the reception of a potting compound. The potting compound secures filter media 205 between opposing end caps 210, 212.

In the embodiment shown, filter assembly 200 also includes a gasket 204 and gasket support structure 206 (e.g., a rectangular frame as shown), which can be bonded to the filter media pack 202 via an adhesive (e.g., urethane or other such similar adhesive). The gasket support structure 206 supports the gasket 204, which surrounds, i.e., circumscribes, the media pack 202 as shown. The gasket 204 may be formed from any material suitable for providing a gasket type seal. Gasket 204 may be pre-formed into its desired shape or molded in place, and then secured to a flange of gasket support structure 206, or the gasket 204 may be constructed integrally with the gasket support structure 206 and/or molded-in-place upon the gasket support structure 206 or the entire structure 206 and 204 may be molded as a single mold-in-place unitary component that is directly molded upon the filter media pack 202 with end caps 210, 212. The gasket 204 may adopt any geometry necessary to provide an adequate seal with an opposing seal surface(s).

In particular embodiments, gasket support structure 206 is a preformed component and may be formed of any material suitable to support gasket 204 and the associated forces exerted on gasket 204 during sealing. As illustrated in FIG. 3, gasket support structure 206 is configured such that gasket 204 is non-parallel to upstream and downstream faces 228, 230 of media pack 202. In the embodiment shown, the inlet face 228 and the outlet face 230 do not have grates covering the faces 228, 230. In alternate embodiments of the invention, a grate may be used to cover one or both of the inlet and outlet faces 228, 230. However, in other embodiments, gasket support structure 206 may be configured such that gasket 204 is positioned parallel to these faces 228, 230. In specific embodiments, the gasket support structure 206 is integral with the gasket 204. Additionally, the gasket support structure 206 is configured to structurally support the gasket 204 and to facilitate attachment of the gasket 204 to the media pack 202 via an adhesive or other attachment means.

The gasket 204 may be assembled to media pack 202 in a manner similar to that described above for the prior art filter assembly 100, except that filter assembly 200 does not include any media support members. That is, in a particular embodiment, the gasket 204 and gasket support structure 206 are attached to the media pack 202 using an adhesive 220. As stated above, the filter assembly 200 does not include any media support members. To provide the structural support to the media pack 202 (provided by media support members in conventional filter assemblies), the filter media pack 202 uses a pair of support panels 222 to provide additional rigidity to the filter media pack 202. The support panels 222 are assembled within the pleated folds of the filter media 205. One panel 222 placed at a first side face 240, with the other panel 222 place at a second side face 242. The aforementioned first end of the filter media 205 may be at the first side face 240, while the aforementioned second end of the filter media 205 is at the second side face 242. In alternate embodiments of the invention, additional support panels 222, e.g., third or fourth support panels 222, may be placed further inboard of the side faces 240, 242, or towards a middle region of the media pack 202.

FIG. 4 is a perspective view that shows how the support panels 222 are assembled within the filter media 205 of media pack 202, and is representative of both opposite sides of the filter media pack 202. As shown in this embodiment, support panel 222 is placed between to two outermost pleat panels 224. In the embodiment shown, the support panels 222 are approximately the same size as each of the panels in the filter media 205, but typically slightly smaller in depth so as to fit easily between to pleat folds/creases. An additional panel 226 is optionally and preferably attached to the outermost panel 224, and wraps around the support panel 222 to secure the support panel 222 in place within the media pack 202. The additional panel 226 may be shorter in length than the other panels of the pleated filter media 205, though other embodiments may include an additional panel 226 that is of the same size as the support panels 222. The filter media 205 may be constructed with an additional panel 226 at each end of the filter media 205. In such a configuration, the additional panels 226 would secure the position of the two support panels 222 at an outboard face 240, 242 of the media pack 202. The support panels 222 may be made from a variety of materials, including but not limited to, polystyrene, matboard/fiberboard, acrylonitrile butadiene styrene (ABS), or a variety of plastics, which can be molded, extruded, corrugated, or used in a composite material. Alternatively, the support panels 222 may be cut to size from larger sheets of material.

With respect to the assembly of filter assembly 200, a support panel 222 may be inserted between any two adjacent pleat panels of the plurality of attached pleat panels in the media pack 202. In the embodiment of FIG. 3, the filter assembly 200 has two support panels 222 each placed at or near the outboard face 240, 242 of the media pack 202. In specific embodiments, the first support panel 222 is placed between two adjacent pleat panels at a first end of the sheet of pleated filter media 205, and the second support panel 222 is placed between two adjacent pleat panels at a second end of the sheet of pleated filter media 205, the second end being opposite the first end. In a further embodiment of the invention, a third support panel 222, and even a fourth support panel 222, may be assembled into the media pack 202 between the first and second support panels 222. In this particular embodiment, none of the support panels 222 are connected.

Referring again to FIG. 3, the filter assembly 200 does not have a flow face support panel as described above in filter assembly 100. In the embodiment shown, the upstream or inlet face 228 optionally is provided with a plurality of adhesive strips 225 placed across the width of the filter media 205 along the upstream or inlet face 228. The plurality of adhesive strips 225 may be spaced apart along a length of the upstream face 228, as shown in FIG. 3. Once the adhesive strips 225 harden, the filter media 205 along the upstream face 228 is fixed in place such that the pleats of the filter media 205 do not separate or compress from their normal or natural state.

Compared to conventional filter assemblies, filter assembly 200 eliminates the need for adhesives to secure the support panels 222 to the media pack 202, and also provides additional rigidity to the filter media pack 202 thereby eliminating the need for external structures and grating structures. Conventional filter assemblies that employ support panels typically use adhesives to attach the support panels to the media pack. The present embodiments use the geometry of the media pack pleats to lock the support panels 222 in position as part of the filter media pack. Additionally, filter assembly 200 does not require media support members, thus reducing the cost of the assembly 200, while simplifying the manufacturing process.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. A filter assembly comprising:
a media pack comprising: (a) a sheet of pleated filter media, the sheet of pleated filter media having a plurality of pleat panels, and (b) a first support panel placed between two adjacent pleat panels in the plurality of the pleat panels; and
a gasket configured to circumscribe the media pack, the gasket being attached to the media pack;
wherein the sheet of pleated filter media includes a first additional panel attached to a last pleat panel at a first end of the sheet of pleated filter media, wherein the first additional panel is configured to wrap around the first support panel to fix the first support panel in position within the media pack.

3. The filter assembly of claim 2, wherein the first additional panel is shorter in length than the first support panel.

4. (canceled)

5. A filter assembly comprising:
a media pack comprising: (a) a sheet of pleated filter media, the sheet of pleated filter media having a plurality of pleat panels, and (b) a first support panel placed between two adjacent pleat panels in the plurality of the pleat panels; and
a gasket configured to circumscribe the media pack, the gasket being attached to the media pack;
wherein the sheet of pleated filter media includes a pair of additional panels, one of the pair of additional panels being attached to a last pleat panel at the first end of the sheet of pleated filter media, the other of the pair of additional panels being attached to a last pleat panel at the second end of the sheet of pleated filter media, wherein the pair of additional panels are each configured to wrap around one of the first and second support panels to fix the first and second support panels in position within the media pack.

6. A filter assembly comprising:
a media pack comprising: (a) a sheet of pleated filter media, the sheet of pleated filter media having a plurality of pleat panels, and (b) a first support panel placed between two adjacent pleat panels in the plurality of the pleat panels; and
a gasket configured to circumscribe the media pack, the gasket being attached to the media pack;
further comprising a third support panel disposed within the media pack between the first and second support panels.

7. A filter assembly comprising:
a media pack comprising: (a) a sheet of pleated filter media, the sheet of pleated filter media having a plurality of pleat panels, and (b) a first support panel placed between two adjacent pleat panels in the plurality of the pleat panels; and
a gasket configured to circumscribe the media pack, the gasket being attached to the media pack;
wherein at least one of the first and second support panels is a thin, flat board.

8. A filter assembly comprising:
a media pack comprising: (a) a sheet of pleated filter media, the sheet of pleated filter media having a plurality of pleat panels, and (b) a first support panel placed between two adjacent pleat panels in the plurality of the pleat panels; and
a gasket configured to circumscribe the media pack, the gasket being attached to the media pack;
further comprising a pair of end caps attached to opposing ends of the media pack such that the first and second support panels each extend from one of the pair of end caps to the other of the pair of end caps.

9. (canceled)

10. (canceled)

11. (canceled)

12. (canceled)

13. A method of manufacturing a filter assembly comprising the steps of:
pleating a sheet of filter media to provide a pleated filter media, wherein the pleated filter media has a plurality of attached pleat panels;
inserting a first support panel between two adjacent pleat panels of the plurality of attached pleat panels to provide a media pack; and
attaching a gasket to the media pack such that the gasket circumscribes the media pack;
further comprising providing the media pack with a first additional panel attached to a last pleat panel at a first end of the sheet of pleated filter media, wherein the first additional panel is configured to wrap around the first support panel to fix the first support panel in position within the media pack.

14. A method of manufacturing a filter assembly comprising the steps of:
pleating a sheet of filter media to provide a pleated filter media, wherein the pleated filter media has a plurality of attached pleat panels;
inserting a first support panel between two adjacent pleat panels of the plurality of attached pleat panels to provide a media pack; and
attaching a gasket to the media pack such that the gasket circumscribes the media pack;
further comprising inserting a second support panel between two adjacent pleat panels of the plurality of attached pleat panels, wherein the first support panel is inserted between two adjacent pleat panels at a first end of the sheet of pleated filter media, and the second support panel is inserted between two adjacent pleat panels at a second end of the sheet of pleated filter media, the second end being opposite the first end.

15. The method of claim 14, further comprising providing the media pack with a pair of additional panels, wherein one of the pair of additional panels is attached to a last pleat panel at the first end of the sheet of pleated filter media, and the other of the pair of additional panels is attached to a last pleat panel at the second end of the sheet of pleated filter media, wherein the pair of additional panels are each configured to wrap around one of the first and second support panels to fix the first and second support panels in position within the media pack.

16. The method of claim 14, further comprising inserting a third support panel within the media pack between the first and second support panels.

17. The method of claim 14, further comprising attaching a pair of end caps to opposing ends of the media pack such that the first and second support panels each extend from one of the pair of end caps to the other of the pair of end caps.

18. (canceled)

19. (canceled)

20. A method of manufacturing a filter assembly comprising the steps of:
pleating a sheet of filter media to provide a pleated filter media, wherein the pleated filter media has a plurality of attached pleat panels;
inserting a first support panel between two adjacent pleat panels of the plurality of attached pleat panels to provide a media pack; and
attaching a gasket to the media pack such that the gasket circumscribes the media pack;
further comprising providing a gasket support structure integral with the gasket, wherein the gasket support structure is configured to structurally support the gasket and to facilitate attachment of the gasket to the media pack with an adhesive.

21. (canceled)

22. A filter assembly, comprising:
a media pack comprising:
(a) a pleated sheet of media having alternating pleat peaks and pleat valleys defined by adjacent media panels, each of the pleats having an upstream portion adjacent a first flow face of the media pack, and a downstream portion adjacent a second flow face of the media pack; and
(b) a planar support member located between an outermost media panel and a first adjacent media panel;
wherein the media pack has a distal media panel folded internally so as to be located between a first inner media panel contiguous with the distal panel, and a second inner media panel contiguous with the first inner media panel, the first inner media panel defining the outermost media panel, and the distal media panel defining the first adjacent media panel.

23. A filter assembly, comprising:
a media pack comprising:
(a) a pleated sheet of media having alternating pleat peaks and pleat valleys defined by adjacent media panels, each of the pleats having an upstream portion adjacent a first flow face of the media pack, and a downstream portion adjacent a second flow face of the media pack; and
(b) a planar support member located between an outermost media panel and a first adjacent media panel;
wherein the planar support member comprises a thin, flat board.
